(19) United States
(12) Patent Application Publication
(10) Pub. No.: US 2026/0066527 A1
(43) Pub. Date: Mar. 5, 2026

(54) DUAL POLARIZED ANTENNA FOR PANEL GAIN FROM LIMITED APERTURE AREA FOR MASSIVE MIMO BASE STATIONS

(71) Applicant: Samsung Electronics Co., Ltd., Suwon-si (KR)

(72) Inventors: Aditya Dave, Frisco, TX (US); Won Suk Choi, McKinney, TX (US); Gang Xu, Allen, TX (US); Jianzhong Zhang, Dallas, TX (US)

(21) Appl. No.: 19/304,514

(22) Filed: Aug. 19, 2025

Related U.S. Application Data
(60) Provisional application No. 63/690,711, filed on Sep. 4, 2024.

(51) Int. Cl. H01Q 1/24; H01Q 13/10; H01Q 19/10; H01Q 21/06; H01Q 21/24; H04B 7/0413

(52) U.S. Cl. CPC H01Q 1/246; H01Q 13/103; H01Q 19/104; H01Q 21/067; H01Q 21/24; H04B 7/0413

(57) ABSTRACT

Apparatuses and methods for a dual-pol antenna for increasing panel gain from limited aperture area for massive MIMO base station in a wireless communication system. A method of a base station (BS) in a wireless communication system includes transmitting polarized electro-magnetic (EM) waves in a direction of a Z-axis via an antenna panel comprising at least one dual polarized antenna and at least one three-dimensional (3D) end-fire antenna, wherein: the at least one dual polarized antenna includes a set of dual polarized antenna elements, at least one individual single polarized antenna element being configured based on a staggered configuration to form the set of dual polarized antenna elements; and the at least one 3D end-fire antenna is configured based on the set of dual polarized antenna elements, the 3D end-fire antenna being oriented in a direction of the Z-axis.

### CROSS-REFERENCE TO RELATED APPLICATIONS AND CLAIM OF PRIORITY

The present application claims priority to U.S. Provisional Patent Application No. 63/690,711, filed on Sep. 4, 2024. The contents of the above-identified patent documents are incorporated herein by reference.

### TECHNICAL FIELD

The present disclosure relates generally to wireless communication systems and, more specifically, the present disclosure relates to a dual polarized (dual-pol) antenna for panel gain from limited aperture area for massive multiple-input multiple-output (MIMO) base station in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to a dual-pol antenna for panel gain from limited aperture area for massive MIMO base station in a wireless communication system.

In one embodiment, a base station (BS) in a wireless communication system is provided. The BS comprises: a processor; an antenna panel comprising at least one dual polarized antenna and at least one three-dimensional (3D) end-fire antenna, wherein: the at least one dual polarized antenna includes a set of dual polarized antenna elements, at least one individual single polarized antenna element being configured based on a staggered configuration to form the set of dual polarized antenna elements, and the at least one 3D end-fire antenna is configured based on the set of dual polarized antenna elements, the 3D end-fire antenna being oriented in a direction of a Z-axis. The BS further comprises a transceiver operably coupled to the processor and the antenna panel, the transceiver configured to transmit polarized electro-magnetic (EM) waves in the direction of the Z-axis via the antenna panel.

In another embodiment, a method of a BS in a wireless communication system is provided. The method comprises: transmitting polarized EM waves in a direction of a Z-axis via an antenna panel comprising at least one dual polarized antenna and at least one 3D end-fire antenna, wherein: the at least one dual polarized antenna includes a set of dual polarized antenna elements, at least one individual single polarized antenna element being configured based on a staggered configuration to form the set of dual polarized antenna elements; and the at least one 3D end-fire antenna is configured based on the set of dual polarized antenna elements, the 3D end-fire antenna being oriented in a direction of the Z-axis.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate examples of wireless transmit and receive paths according to this disclosure;

FIG. 6 illustrates an example of a comparison of 2λ and 4λ subarray size to maintain same number of RF chains according to embodiments of the present disclosure;

FIG. 7 illustrates an example of structure of dual-pol Vivaldi antenna element with parasitic elements for gain improvement with height reduction according to embodiments of the present disclosure;

FIG. 8 illustrates an example of a dual-pol Vivaldi antenna with staggered configuration according to embodiments of the present disclosure;

FIG. 9 illustrates a flowchart of method for determining if Vivaldi based staggered MMU antenna is correct choice according to embodiments of the present disclosure;

FIG. 10 illustrates an example of size comparison of planar antenna MMU and 3D Vivaldi based staggered dual orthogonal polarized antenna MMU for same gain according to embodiments of the present disclosure;

FIG. 11 illustrates an example of a comparison of overall size of the planar antenna array panel and the 3D Vivaldi based staggered antenna array panel for achieving the same overall gain according to embodiments of the present disclosure;

FIG. 12 illustrates an example of smaller antenna element spacing for reducing degradation in the scan range seen by using high gain low beamwidth individual antenna elements according to embodiments of the present disclosure;

FIG. 13 illustrates an example of dual orthogonal antenna panel using 0/90 polarization according to embodiments of the present disclosure;

FIG. 14 illustrates an example of splitting each element in 1×2 array to achieve non staggered 45/135 polarization according to embodiments of the present disclosure; and

FIG. 15 illustrates a flowchart of method for a dual-pol antenna for increasing panel gain from limited aperture area for massive MIMO base station in a wireless communication system according to embodiments of the present disclosure.

### DETAILED DESCRIPTION

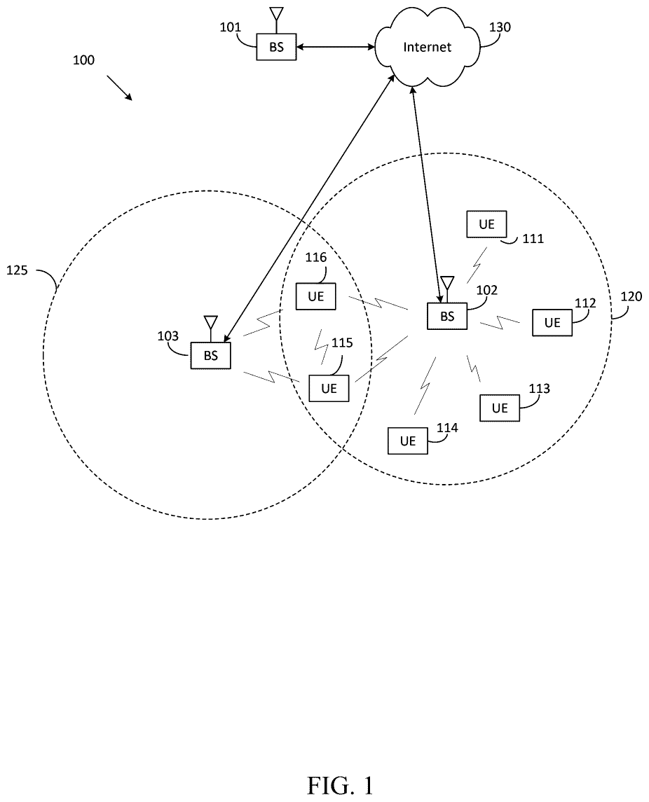

FIGS. 1-15, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example of wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered as a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for receiving a signal generated from a dual-pol antenna for increasing panel gain from limited aperture area for massive MIMO base station in a wireless communication system. In certain embodiments, and one or more of the gNBs 101-103 includes circuitry, programing, or a combination thereof, for supporting an operation for configurations for a dual-pol antenna for increasing panel gain from limited aperture area for massive MIMO base station in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

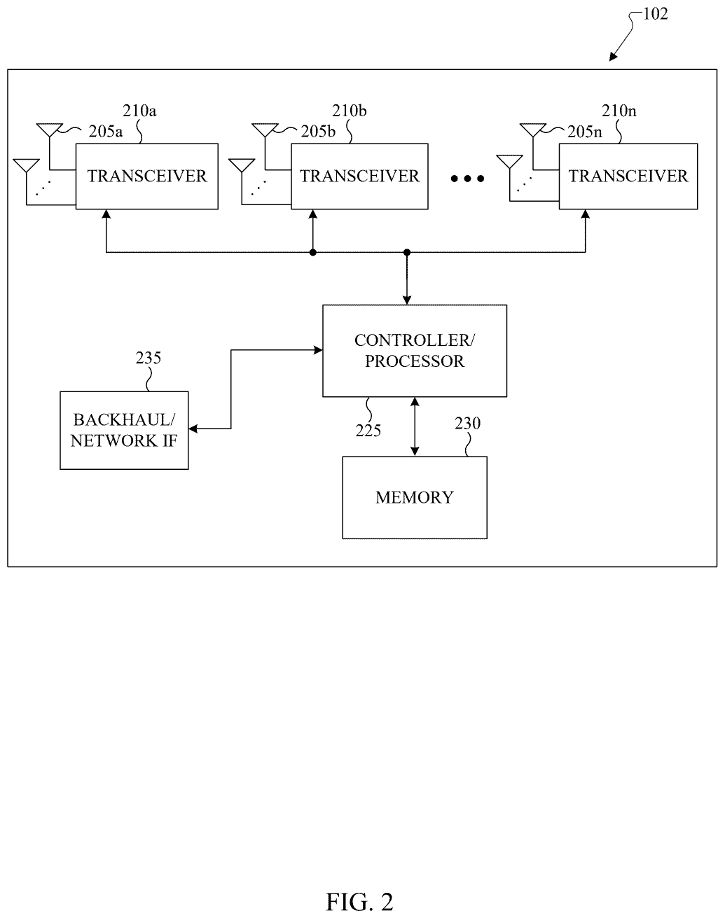

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for supporting a dual-pol antenna for increasing panel gain from limited aperture area for massive MIMO base station in a wireless communication system. The controller/processor 225 can move data into or out of the memory 230 as performed by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

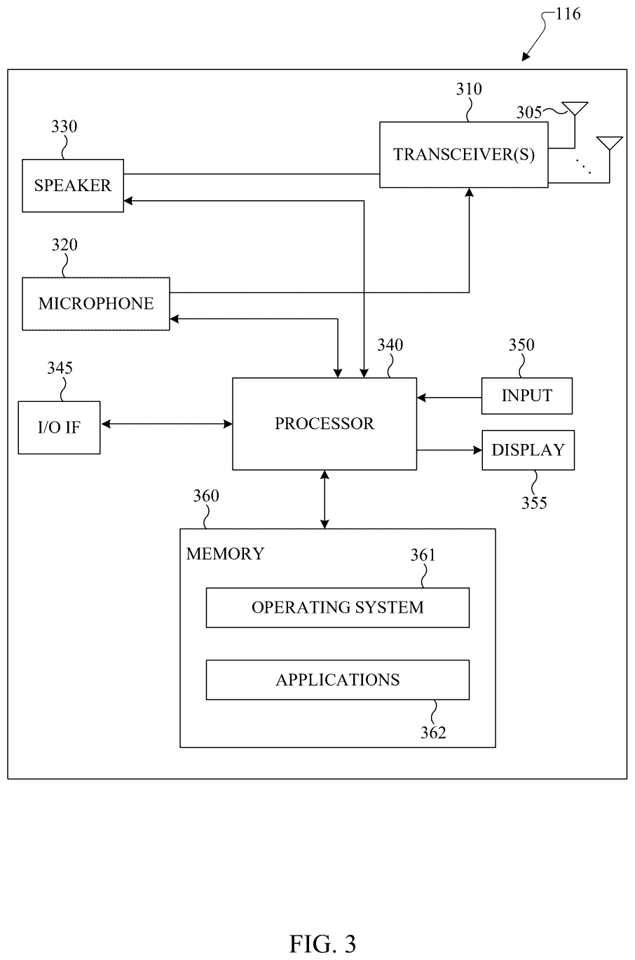

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for receiving a signal generated from a dual-pol antenna for increasing panel gain from limited aperture area for massive MIMO base station in a wireless communication system.

The processor 340 can move data into or out of the memory 360 as performed by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355 which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

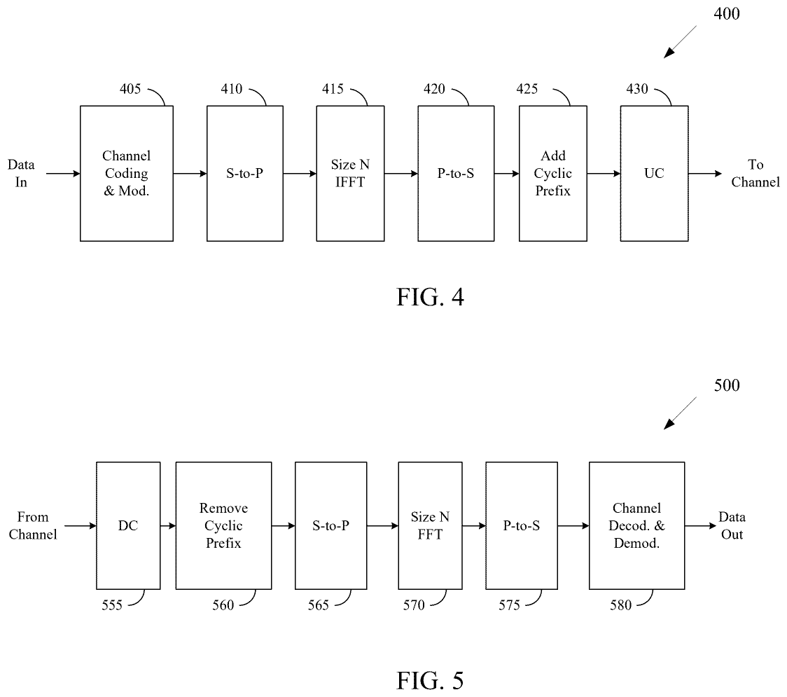

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In various embodiments, the receive path 500 can be implemented in a first UE and the transmit path 400 can be implemented in a second UE. In some embodiments, the transmit path 400 is configured to utilize a dual-pol antenna for increasing panel gain from limited aperture area for massive MIMO base station in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

For superior coverage at communication bands like a frequency range 1 (FR1), an FR2, and an FR3, it is necessary to boost the antenna gain from base-station antenna panels. This can be accomplished by either making the antenna size larger or by making the antenna aperture more efficient. For increasing the antenna panel gain by 3 dB, it is necessary to double the antenna panel size if individual antenna elements are the same. Doubling the size increases the weight of the panel by two times and it may also be difficult to implement due to size and wind load constraints. Enhancing the antenna's aperture efficiency in X-Y plane is very hard with already ˜100% efficient antennas used in base-station modules. In this way, not more than 0.2-0.3 dB gain improvement can be obtained from same aperture size, even if 100% efficient antennas are used. In this case, for obtaining 3 dB larger antenna gain, the antenna panel size is still necessary to increase by just a little lower than two times.

For base-station antennas, it can be assumed that the antenna is implemented in the X-Y plane and radiates along the Z-direction. For truly doubling the antenna panel gain without increasing the size of the panel by two times, it is necessary to utilize the Z-dimension for antenna implementation. By utilizing antenna aperture in X-Z or Y-Z direction, the X-Y aperture efficiency limit may be ignored. In this way, more antennas can be placed in the X-Y plane, with each element having a larger element gain than other used base-station antennas. Such end-fire antennas are shown to improve the gain of the antenna panel by 3 dB without doubling the size of the panel. Such antennas also have better cross-pol isolation compared to antennas where both orthogonal radiation modes are supported on the same radiating element.

The fundamental problem is to increase the gain of the antenna panel on the massive MIMO unit (MMU) base-station. With increasing urban densification, it is proving difficult to effectively deploy 5G in dense urban areas due to reduced power resulting from obstacle-based attenuation. Alternatively, in non-dense environments, improving coverage of base-stations can give larger throughput at the same coverage distance, and improve the coverage distance for meeting the minimum SNR at the receiver. This can save on massive infrastructure costs resulting due to reduced number of base-stations for providing coverage.

The antenna design for base-station focuses on broadside antenna radiators that use the X-Y plane for an element design and a Z-direction for radiation. The aperture efficiency of such an antenna panel is given by equation (1):

$${ε}_{AP} = \frac{G {λ}^{2}}{4 π {A}_{ph}} . \qquad ( 1 )$$

In equation (1), G is the gain of the antenna, A is the operational wavelength, and Δₚₕ is the physical area. According to this formula, there is only a finite amount of gain that can be extracted from a limited X-Y area. The antennas in the FR1 and FR3 product tend to be more than 90% efficient. If these antennas were exactly 100% aperture efficient, the additional gain improvement due to 10% efficiency increase may only be 0.4 dB. Also, it is impossible to design an antenna with 100% efficiency considering all the finite substrate losses, conductor losses and mutual coupling.

Hence, the present disclosure provides techniques that can increase the gain of the antenna panel on the base-station apart from improving the performance of the broadside antennas. In the present disclosure, two methods are provided to improve the gain of the antenna panel (1) increasing the antenna panel size and (2) increasing element gain.

In one embodiment, this approach involves making the antenna panel larger in the vertical direction to refrain from increasing the number of RF chains. In the vertical direction, product MMUs already comprise subarray implementation. A subarray size of 2λ can be used in the vertical direction with 3 elements spaced 0.66λ apart or 4 elements placed 0.5λ apart. All the elements in the subarray are driven with the same phase since they are attached to only 1 power amplifier (PA) and a radio frequency integrated circuit (RFIC) phase shifter. In order to increase the antenna panel size by two times to extract a 3 dB larger gain, the subarray size is necessary to increase to 4λ with 6 or 8 elements to maintain the original number of RF chains.

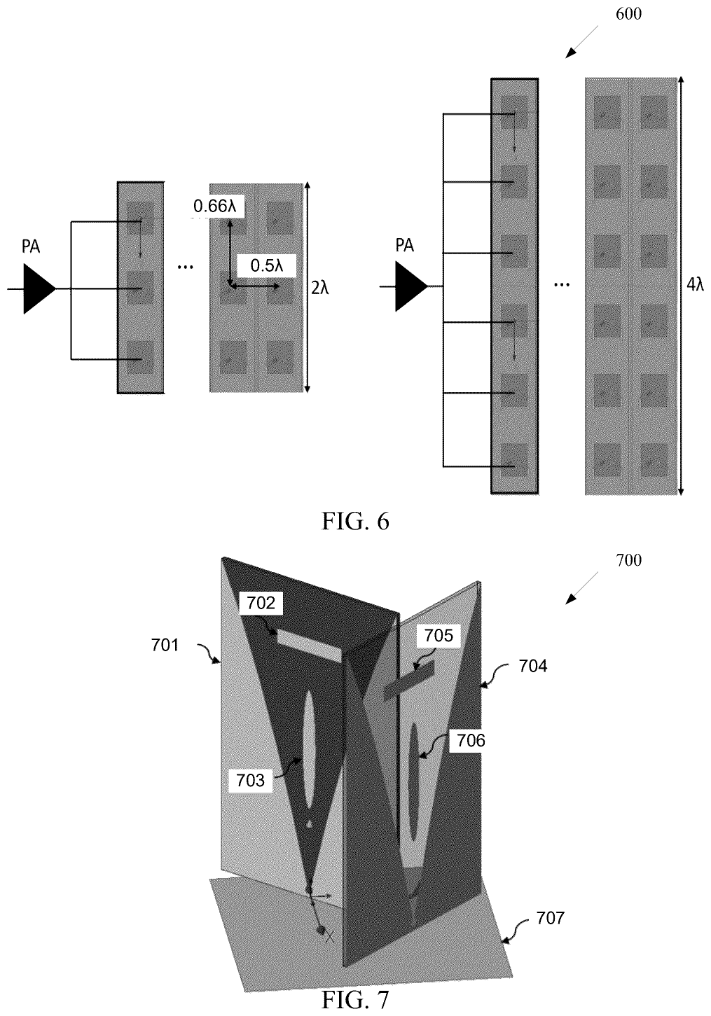

FIG. 6 illustrates an example of a comparison of 2λ and 4λ subarray size 600 to maintain the same number of RF chains according to embodiments of the present disclosure. An embodiment of the comparison of 2λ and 4λ subarray size 600 shown in FIG. 6 is for illustration only.

The comparison between both these architectures is shown in FIG. 6. In this case, although the overall antenna gain is increased and the Azimuth steering is unaffected due to no change in horizontal antenna spacing, the vertical scan range is almost halved due to double spacing of 4λ between phase centers of adjacent subarray. With a 2λ spacing, the theoretical maximum steer range is 25°. But due to the increase in the subarray size to maintain the same number of RF chains with a larger antenna panel size, the steering range is reduced to about 15°. This is understood by determining the element phase shift range based on the subarray spacing and desired steer angle as shown in Equation (2).

Equation (1) is only valid if all the antenna elements are in the X-Y plane and radiating broadside in the Z-direction. Using Equation (2), the beam direction can be also predicted if the inter-element phase shift is known:

$$θ = {sin}^{- 1} [ \frac{1}{2 π} ( \frac{λ}{d} ) φ ] . \qquad ( 2 )$$

The maximum phase-shift between elements for generating an independent solution for phase shift is 180°. In Equation (2), the d specifies the distance between the phase centers of the subarray. When d=2λ, the maximum value of θ is ±14.47°. When d=4λ, i.e., the subarray size is made twice, the maximum value of θ is ±7.18°.

The degradation in the elevation steer range is a major drawback. To solve this issue, additional tuning after the PA may be implemented. Using electronic phase shifter (EPS) solutions by incorporating diodes and varactors in the power divider is one way of recovering the phase steer. However, these tuning elements introduce additional loss and reduce the gain of the antenna panel such that even two times the panel size gives less than 3 dB gain increment.

The present disclosure provides a solution for the second problem of the increased panel size. Most of the operators have strict specifications on the overall panel size for the MMU. Increasing the panel size by two times is not a feasible way to produce 3 dB larger EIRP. Hence even though the vertical steering range is compromised, the fact that the panel size is increased by two times renders this idea infeasible.

In one embodiment, increasing the element gain can help to increase the overall antenna panel gain. The antenna panel gain is given by the sum of element gain and the normalized array factor. The normalized array factor is dependent on the spacing and the number of elements and tends to be constant. Hence if the element gain is 3 dB larger, the overall panel gain can increase by 3 dB. But this leads to the original problem of aperture efficiency.

According to Equation (1), the aperture efficiency cannot increase beyond 100% for the single element. Hence if a similar broadside radiating antenna is tried to optimally produce 3 dB higher gain (or 50% higher aperture efficiency), it can only happen if the original antenna element has 50% or lower efficiency. Most commercial product antennas have an antenna only efficiency of >90%, which reduces the scope of increasing the gain beyond a very minimal value even if 100% efficient antennas are designed.

To overcome the drawback of approaching near 100% efficiency while designing the antennas, it is necessary to change the design philosophy. If antennas are not limited to the X-Y plane, then the aperture efficiency limit imposed by 2D apertures can be broken. The idea thus involves the use of 3D end-fire antennas, where the antennas are primarily oriented in the Z-direction and also radiate in the Z-direction. Then, by controlling the length of the antenna on Z-axis, the gain of each element can be increased or decreased. Also, in this way, more antennas in the X-Y plane can be packed and thereby have more RF ports in the same overall area.

In the present disclosure, (i) utilizing one or more 3D end-fire antennas oriented and radiating in a Z-direction to reduce antenna panel size while maintaining MMU antenna gain are provided and (ii) integrating dual polarized 45-degree and 135-degree design with a high gain MMU antenna element based on a staggered configuration of one or more individual single polarized antenna elements is provided.

For increasing the element gain, a high gain end-fire Vivaldi based MMU antenna panel is provided. FIG. 7 shows the antenna element with parasitic structures for gain enhancement and size reduction.

FIG. 7 illustrates an example of a structure of dual-pol Vivaldi antenna element 700 with parasitic elements for gain improvement with height reduction according to embodiments of the present disclosure. An embodiment of the structure of dual-pol Vivaldi antenna element 700 shown in FIG. 7 is for illustration only.

Some Vivaldi antenna elements have a height that is in multiple orders of wavelengths to achieve high gain. For the antenna in FIG. 7, the height is only 1λ, indicating that high gain can be obtained using limited structural dimension of the antenna. The antenna in FIG. 7 includes two linearly polarized antennas that can as one combined element radiate dual orthogonal cross-polarized EM waves. 701 shows one polarization of the Vivaldi element that radiates 45° Polarized EM waves. The structure includes a tapered sloe antenna with a light region indicating metal and dark region indicating dielectric. The antenna is made on a single layer PCB material with thickness of 0.005λ-0.04λ. The length of the antenna element can vary from 0.96λ-4λ and the width can vary from 0.3λ-0.6λ.

As illustrated in FIG. 7, 702 is a parasitic rectangular element that increases the gain of the antenna element 701 by increasing the effective length where EM waves can radiate coherently. 703 includes an elliptical parasitic element with also increases the gain of the antenna element 701 and controls the resonance frequency based on major axis and eccentricity parameter of the ellipse. 704 is the second antenna element that radiates 135° polarized EM waves. 705 includes a rectangular element with dimensions similar to 702 and helps to increase the gain of antenna element 704. 706 includes a parasitic elliptical element that has dimensions similar to 703 and helps to increase gain and change resonance frequency of antenna element 704. 707 is a metal plate that acts like a reflector for EL waves to radiate in only the upper half region of the antenna. This also increases the gain of the antenna and increases the front-to-back ratio by reducing the leakage of electromagnetic waves in an undesired direction. 707 also acts as a baseboard for integrating individual Vivaldi elements into it to make a larger antenna array panel.

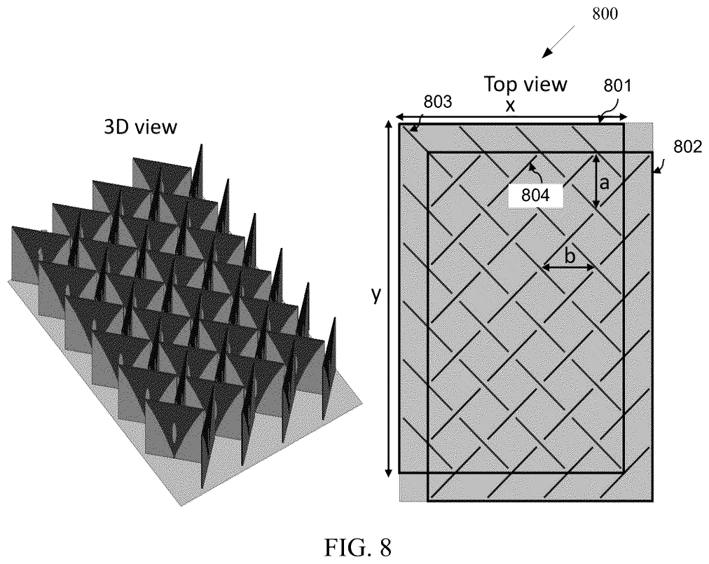

FIG. 8 illustrates an example of dual-pol Vivaldi antenna with staggered configuration 800 according to embodiments of the present disclosure. An embodiment of the dual-pol Vivaldi antenna with staggered configuration 800 shown in FIG. 8 is for illustration only.

Sone dual polarized Vivaldi structures are implemented using 0° and 90° dual-polarized structures in horizontal and vertical orientation. The present disclosure uses staggered arrangement of antenna elements to get high, gain, low mutual coupling and high cross-pol isolation. FIG. 8 shows the finite array with staggered arrangement of dual-polarized antenna elements in 3D view and the top view. The second staggered polarization is 0.152-0.32 offset in horizontal and vertical direction from the first polarization as seen in the top view. The 45° polarization is indicated by 203. The staggered 135° polarization is indicated by 804. The overall panel for one polarization is indicated by a size of x in horizontal direction and y in vertical direction.

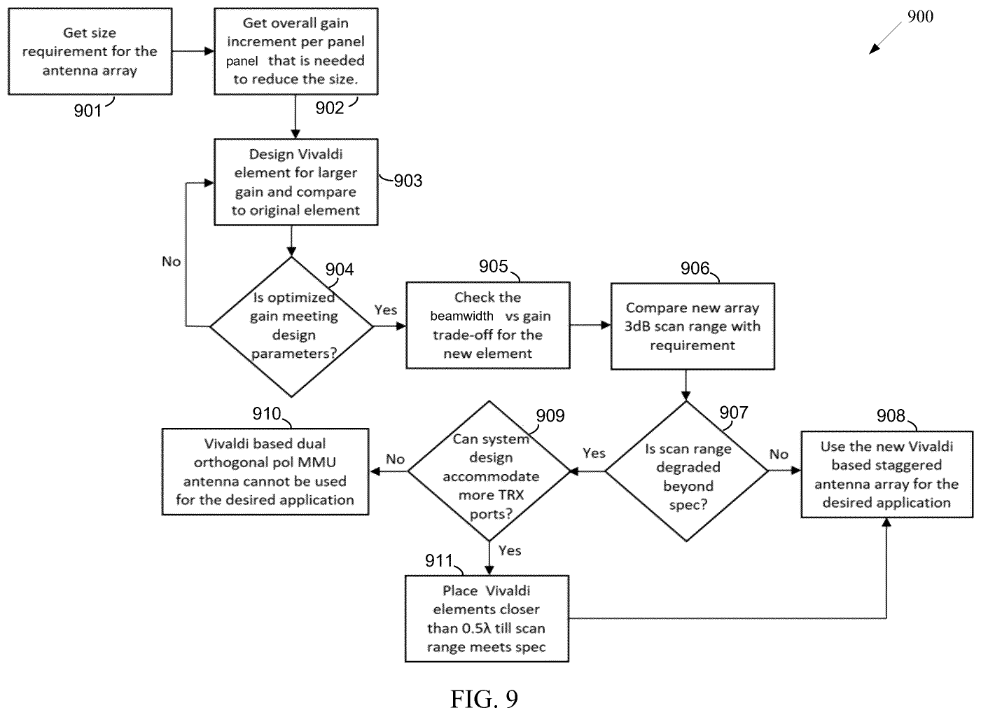

As illustrated in FIG. 8, the panel enclosure for the first polarization is indicated by 801. The second polarization in 802 shares most of the area with 801 with only 1 element offset lying outside the 801 panel in the horizontal and the vertical direction. The dimensions of x and y are determined by the overall antenna array gain requirement. The number of antenna elements for each polarization within one panel are dictated by the element spacing requirements which can vary from 0.3λ to 0.8λ. Larger element spacing leads to a smaller number of RF chains and vice-versa. This change in the number of TRX ports directly affects the steering capability of the antenna array. The larger element gain for the Vivaldi based MMU antenna element as compared to the patch antenna elements leads to lower element beamwidth. Hence, with the 0.52 spacing, the Vivaldi MMU antenna array has a lower scan capability as compared to the antenna array where antenna element has a lower gain but a wider beamwidth. One way to alleviate this problem is by having elements for Vivaldi MMU antenna array placed closer to each other. This leads to increase in scanning capability but also increases the number of TRX ports in the same panel area, which can have positive or negative system consequences. This way to reduce the antenna panel size by increasing the gain of the individual antenna elements, at cost of reducing the scan range, or increasing the number of TRX ports is indicated by the flowchart in FIG. 9.

FIG. 9 illustrates a flowchart of method 900 for determining if Vivaldi based staggered MMU antenna is correct choice according to embodiments of the present disclosure. The method 900 may be performed by a BS (e.g., 101-103 as illustrated in FIG. 1). An embodiment of the method 900 shown in FIG. 9 is for illustration only. One or more of the components illustrated in FIG. 9 can be implemented in specialized circuitry configured to perform the noted functions or one or more of the components can be implemented by one or more processors executing instructions to perform the noted functions.

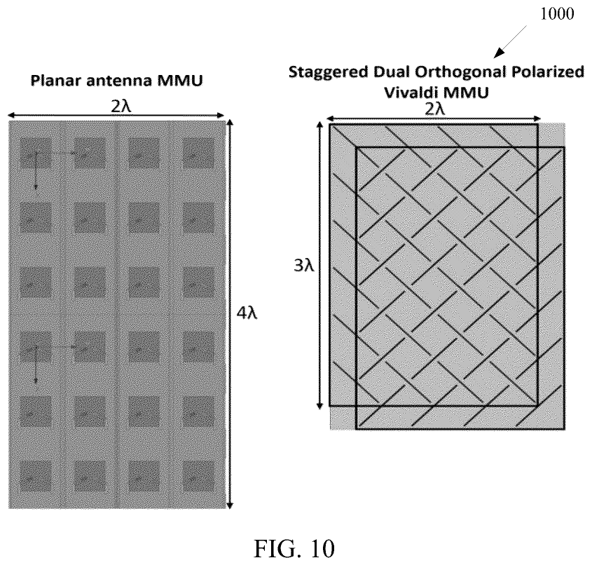

As illustrated in FIG. 9, 901 is used at the beginning to get the size requirement for the antenna panel. It is assumed at this point that the array gain cannot be met using other planar antenna approaches. Based on the additional gain that is necessary for the antenna panel, the Vivaldi antenna element is designed. Larger height of the antenna results in larger element gain at the cost of reduced 3 dB beamwidth in 902. In 903, the antenna array gain for the staggered dual-pol Vivaldi element is compared to planar antenna based array. A comparison of the size of antenna array and staggered dual-pol Vivaldi antenna array for meeting the same gain is shown in FIG. 10.

FIG. 10 illustrates an example of size comparison of planar antenna MMU and 3D Vivaldi 1000 based staggered dual orthogonal polarized antenna MMU for same gain according to embodiments of the present disclosure. An embodiment of the size comparison of planar antenna MMU and 3D Vivaldi 1000 shown in FIG. 10 is for illustration only.

The comparison is made for one instance of array size. The array, however, can be scaled to any larger or smaller size and the same comparison with scaled values for gain may still be valid.

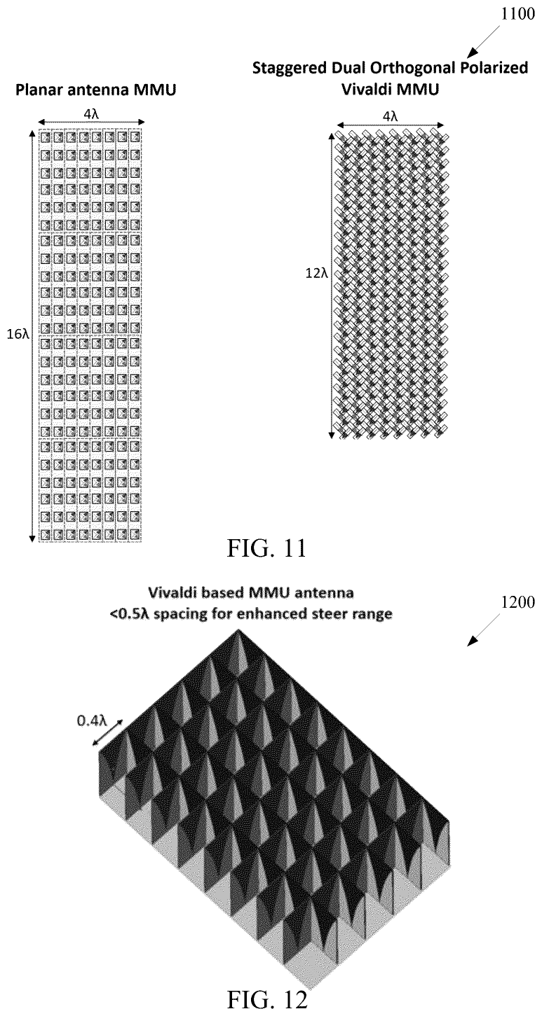

The array in FIG. 10 is scaled to a larger size to meet the gain requirements for the base-station MMU antenna panel. The scaled antenna structure with polarization directions indicated by the arrow is shown in FIG. 11 for obtaining 3 dB larger gain than a product gain of 26 dBi.

FIG. 11 illustrates an example of a comparison of overall size of the planar antenna array panel and the 3D Vivaldi 1100 based staggered antenna array panel for achieving the same overall gain according to embodiments of the present disclosure. An embodiment of the comparison of overall size of the planar antenna array panel and the 3D Vivaldi 1100 shown in FIG. 11 is for illustration only.

As illustrated in overall size of FIG. 11, the planar MMU occupies an area of 162×42 which is double that of the product area of 8λ×4λ to obtain 3 dB larger gain of 29 dBi. The staggered dual pol Vivaldi MMU antenna, however, only occupies 1.5× area (1λ×4λ) compared to a product area to obtain the same 29 dBi gain. This 3 dB additional gain comes at cost of larger panel height in the Z-direction.

In step 904 of FIG. 9, it is evaluated if the increased gain can meet the design requirements. Once the requirements are met, as for the example in FIG. 11, the element beamwidths are compared for another element and the high gain staggered dual-pol Vivaldi element. For the example illustrated in FIG. 11, it is seen that the element beamwidth for the staggered dual-pol Vivaldi element is 20° smaller in the azimuth direction as compared for the other planar antenna MMU. This translates to an overall steering range reduction of 20° if same element spacing as planar MMU antenna is maintained. This steering range and gain trade-off can be made smaller if the gain increment desired from the Vivaldi antenna panel is lower. The steering range reduction of 20° is also just one example.

Depending on a design of the MMU antenna, there may be more or less or no steering range reduction. Once the 3 dB scan range requirement is assessed in step 906 in FIG. 9, it is evaluated if the degraded scan range is acceptable for the MMU antenna application by reviewing the system requirements. If the degraded scan range is acceptable in step 907 of FIG. 9, the MMU antenna can be used without any further changes in step 908 of FIG. 9. If the degraded scan range is not acceptable, one way to improve the scan range is by having more TRX ports in the same area, thereby having smaller spacing between the adjacent antenna elements in step 909 of FIG. 9.

Using smaller element spacing, the scan range can be improved until the specification for MMU antenna panel is met in step 911 of FIG. 9. Placing more TRX ports can influence the beam design and number of users serviced simultaneously. This changes the beam and frequency allocation drastically and may have positive or negative effects on overall system performance. Hence if number of TRX ports cannot be changed the beam scanning range does not meet the requirements, even though the Vivaldi based staggered MMU antenna panel produces more gain using smaller area, it cannot be used in the MMU application as indicated by step 910.

An advantage of using such a Vivaldi antenna structure is the ability to get a larger antenna gain than other patch types of antenna elements. An approach disclosed herein for using staggered individual antenna element configuration is to generate dual orthogonal 45° and 135° polarized MMU antenna is shown. The designed MMU antenna can produce the same gain using much smaller area than other planar antenna approaches and can be used in MIMO applications in base-station environment.

In one embodiment, scan range reduction addressed using closer spaced Vivaldi antenna elements is provided.

FIG. 12 illustrates an example of smaller antenna element spacing 1200 for reducing degradation in the scan range seen by using high gain low beamwidth individual antenna elements according to embodiments of the present disclosure. An embodiment of the smaller antenna element spacing 1200 shown in FIG. 12 is for illustration only.

Larger element gain with 0.52 spacing results in smaller scan range. In FIG. 12, an alternate 3D Vivaldi based antenna array is shown with smaller antenna element spacing to meet the ±50° scan range requirement.

In one embodiment, Vivaldi antenna element with 0°/90° polarization instead of another 45°/135° polarization is provided.

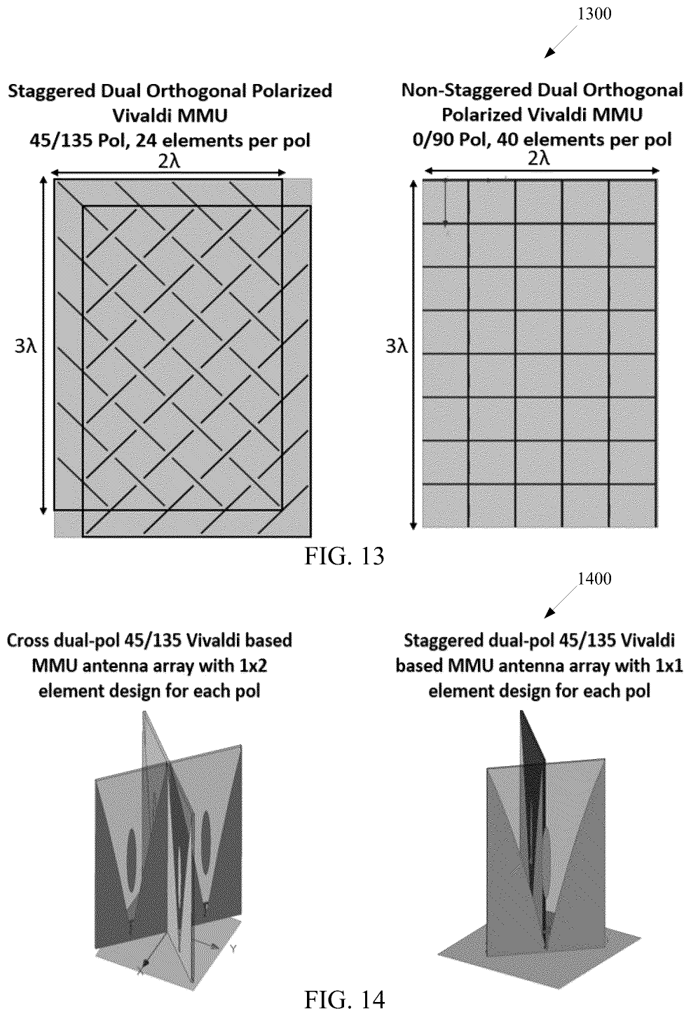

FIG. 13 illustrates an example of dual orthogonal antenna panel 1300 using 0/90 polarization according to embodiments of the present disclosure. An embodiment of the dual orthogonal antenna panel 1300 shown in FIG. 13 is for illustration only.

MMU antennas are based on 45°/135° polarization requirement. However, if 0° and 90° polarization is used, then it is possible to further reduce size of the MMU array without using staggered configuration as shown in FIG. 13. With additional elements in closer spacing, the steer range reduction is also eliminated. FIG. 13 illustrates a dual orthogonal antenna panel using 0/90 Polarization as an alternate embodiment to the staggered 45/135 Polarization.

In one embodiment, using 1×2 array for each Vivaldi element to intersect two polarizations at the center instead of staggering them is provided.

The primary embodiment uses staggered dual-orthogonal Vivaldi MMU antenna element. This is because if both polarizations occupied the same space by forming an X design instead of a T as seen from top-view, the center of each element may intersect with one another. Since each element is fed from the center, it may not be possible to feed both polarizations simultaneously. In this embodiment, each Vivaldi element is further split into a 1×2 array with each element in the array having reduced size as compared to the antenna element. In this way, at the center of the substrate there is a common ground plane which can be shared by both the polarizations. In this way, without staggering, dual-pol Vivaldi based MMU antenna can be supported as shown in FIG. 14.

FIG. 14 illustrates an example of splitting each element in 1×2 array 1400 to achieve non staggered 45/135 polarization according to embodiments of the present disclosure. An embodiment of the splitting each element in 1×2 array 1400 shown in FIG. 14 is for illustration only.

FIG. 14 illustrates splitting each element in 1×2 array to achieve non staggered 45/135 Polarization on left as compared to primary embodiment of staggered configuration with single element for each polarization on the right.

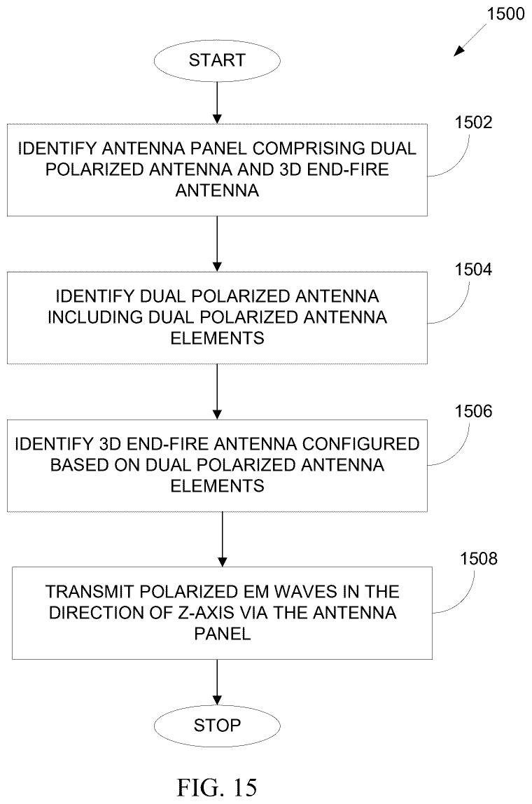

FIG. 15 illustrates a flowchart of method 1500 for a dual-pol antenna for increasing panel gain from limited aperture area for massive MIMO base station in a wireless communication system according to embodiments of the present disclosure. The method 1500 may be performed by a BS (e.g., 101-103 as illustrated in FIG. 1). An embodiment of the method 1500 shown in FIG. 15 is for illustration only. One or more of the components illustrated in FIG. 15 can be implemented in specialized circuitry configured to perform the noted functions or one or more of the components can be implemented by one or more processors executing instructions to perform the noted functions.

As illustrated in FIG. 15, the method 1500 begins at step 1502. In step 1502, a BS identifies an antenna panel comprising at least one dual polarized antenna and at least one 3D end-fire antenna.

In step 1504, the BS identifies the at least one dual polarized antenna includes a set of dual polarized antenna elements, at least one individual single polarized antenna element being configured based on a staggered configuration to form the set of dual polarized antenna elements.

In step 1506, the BS identifies the at least one 3D end-fire antenna is configured based on the set of dual polarized antenna elements, the 3D end-fire antenna being oriented in a direction of a Z-axis.

In step 1508, the BS transmits polarized EM waves in the direction of the Z-axis via the antenna panel.

In one embodiment, the BS maintains a massive MMU antenna gain as a same level of antenna gain while transmitting the EM waves via the antenna panel.

In one embodiment, the set of dual polarized antenna elements comprises at least one orthogonal polarized antenna element.

In one embodiment, at least one orthogonal polarized antenna element is configured based on a 45 degree configuration and a 135 degree configuration.

In one embodiment, the 45 degree configuration and the 135 degree configuration are integrated with a set of massive MMU antenna elements based on the staggered configuration.

In one embodiment, at least one dual polarized antenna and the at least one 3D end-fire antenna are configured based on a tapered slot antenna structure with a first plate including a metal portion and a second plate including a dielectric portion.

In one embodiment, the first plate is configured to reflect the EM waves to radiate in an upper half region of the antenna panel to increase an antenna gain and a front-back ratio by reducing a leakage of the EM waves.

In one embodiment, a parasitic element of the antenna panel comprises a rectangular parasitic element and an elliptical parasitic element, the rectangular parasitic element is configured to increase a gain of antenna element by increasing a length where the EM waves radiate coherently, and the elliptical parasitic element is configured to increase the gain of the antenna element and control a resonance frequency based on a dominant axis and an eccentricity parameter of an ellipse.

In one embodiment, the staggered configuration comprises a staggered polarization with an offset between 0.15λ and 0.3λ in a horizontal and vertical direction.

In one embodiment, a dimension of the antenna panel is based on an antenna array gain requirement associated with a number of antenna elements for each polarization within the antenna panel.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A base station (BS) in a wireless communication system, the BS comprising:
a processor;
an antenna panel comprising at least one dual polarized antenna and at least one three-dimensional (3D) end-fire antenna, wherein:
the at least one dual polarized antenna includes a set of dual polarized antenna elements, at least one individual single polarized antenna element being configured based on a staggered configuration to form the set of dual polarized antenna elements, and
the at least one 3D end-fire antenna is configured based on the set of dual polarized antenna elements, the 3D end-fire antenna being oriented in a direction of a Z-axis; and
a transceiver operably coupled to the processor and the antenna panel, the transceiver configured to transmit polarized electro-magnetic (EM) waves in the direction of the Z-axis via the antenna panel.

2. The BS of claim 1, wherein the processor is configured to maintain a massive multi-input multi-output unit (MMU) antenna gain as a same level of antenna gain while transmitting the EM waves via the antenna panel.

3. The BS of claim 1, wherein the set of dual polarized antenna elements comprises at least one orthogonal polarized antenna element.

4. The BS of claim 3, wherein at least one orthogonal polarized antenna element is configured based on a 45 degree configuration and a 135 degree configuration.

5. The BS of claim 4, wherein the 45 degree configuration and the 135 degree configuration are integrated with a set of massive multi-input multi-output unit (MMU) antenna elements based on the staggered configuration.

6. The BS of claim 1, wherein at least one dual polarized antenna and the at least one 3D end-fire antenna are configured based on a tapered slot antenna structure with a first plate including a metal portion and a second plate including a dielectric portion.

7. The BS of claim 6, wherein the first plate is configured to reflect the EM waves to radiate in an upper half region of the antenna panel to increase an antenna gain and a front-back ratio by reducing a leakage of the EM waves.

8. The BS of claim 1, wherein:
a parasitic element of the antenna panel comprises a rectangular parasitic element and an elliptical parasitic element;
the rectangular parasitic element is configured to increase a gain of antenna element by increasing a length where the EM waves radiate coherently; and
the elliptical parasitic element is configured to increase the gain of the antenna element and control a resonance frequency based on a dominant axis and an eccentricity parameter of an ellipse.

9. The BS of claim 1, wherein the staggered configuration comprises a staggered polarization with an offset between 0.152 and 0.32 in a horizontal and vertical direction.

10. The BS of claim 1, wherein a dimension of the antenna panel is based on an antenna array gain requirement associated with a number of antenna elements for each polarization within the antenna panel.

11. A method of a base station (BS) in a wireless communication system, the method comprising:
transmitting polarized electro-magnetic (EM) waves in a direction of a Z-axis via an antenna panel comprising at least one dual polarized antenna and at least one three-dimensional (3D) end-fire antenna,
wherein:
the at least one dual polarized antenna includes a set of dual polarized antenna elements, at least one individual single polarized antenna element being configured based on a staggered configuration to form the set of dual polarized antenna elements; and
the at least one 3D end-fire antenna is configured based on the set of dual polarized antenna elements, the 3D end-fire antenna being oriented in a direction of the Z-axis.

12. The method of claim 11, further comprising maintaining a massive multi-input multi-output unit (MMU) antenna gain as a same level of antenna gain while transmitting the EM waves via the antenna panel.

13. The method of claim 11, wherein the set of dual polarized antenna elements comprises at least one orthogonal polarized antenna element.

14. The method of claim 13, wherein at least one orthogonal polarized antenna element is configured based on a 45 degree configuration and a 135 degree configuration.

15. The method of claim 14, wherein the 45 degree configuration and the 135 degree configuration are integrated with a set of massive multi-input multi-output unit (MMU) antenna elements based on the staggered configuration.

16. The method of claim 11, wherein at least one dual polarized antenna and the at least one 3D end-fire antenna are configured based on a tapered slot antenna structure with a first plate including a metal portion and a second plate including a dielectric portion.

17. The method of claim 16, wherein the first plate is configured to reflect the EM waves to radiate in an upper half region of the antenna panel to increase an antenna gain and a front-back ratio by reducing a leakage of the EM waves.

18. The method of claim 11, wherein:
a parasitic element of the antenna panel comprises a rectangular parasitic element and an elliptical parasitic element;
the rectangular parasitic element is configured to increase a gain of antenna element by increasing a length where the EM waves radiate coherently; and
the elliptical parasitic element is configured to increase the gain of the antenna element and control a resonance frequency based on a dominant axis and an eccentricity parameter of an ellipse.

19. The method of claim 11, wherein the staggered configuration comprises a staggered polarization with an offset between 0.152 and 0.32 in a horizontal and vertical direction.

20. The method of claim 11, wherein a dimension of the antenna panel is based on an antenna array gain requirement associated with a number of antenna elements for each polarization within the antenna panel.
